(19) United States
(12) Patent Application Publication
(10) Pub. No.: US 2014/0355299 A1
(43) Pub. Date: Dec. 4, 2014

(54) LIGHT GUIDE PLATE HAVING RIBS AND BACKLIGHT MODULE HAVING SAME

(71) Applicant: HON HAI PRECISION INDUSTRY CO., LTD., New Taipei (TW)

(72) Inventor: YUNG-CHANG TSENG, New Taipei (TW)

(73) Assignee: HON HAI PRECISION INDUSTRY CO., LTD., New Taipei (TW)

(21) Appl. No.: 14/188,105

(22) Filed: Feb. 24, 2014

(30) Foreign Application Priority Data
May 31, 2013 (TW) 102119516

(51) Int. Cl. F21V 8/00

(52) U.S. Cl. CPC G02B 6/0036; G02B 6/0053
USPC 362/606; 362/626

(57) ABSTRACT

A light guide plate includes a bottom surface, a light-emitting surface, a light incident surface, a first side surface, a second side surface, and a number of ribs protruding from the bottom surface away from light-emitting surface. The ribs extend substantially parallelly from the first side surface to the second side surface and are continuously arranged without gaps in between. Each rib includes a first surface, a second surface, and a third surface. The first surface and the second surface extend from the bottom surface. The second surface is further from the light incident surface than is the first surface. A first included angle between the first surface and the bottom surface is an acute angle, and the third surface connects the first surface to the second surface.

### BACKGROUND

1. Technical Field

The present disclosure relates to a backlight module and a light guide plate used in the backlight module.

2. Description of Related Art

Light guide plates usually form projections on bottom surfaces thereof to reflect light in different directions. However, the reflected light cannot concentrate along a particular direction, which reduces a brightness of the light guide plate.

Therefore, it is desirable to provide a light guide plate and a backlight module the can overcome the shortcomings mentioned above.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic, isometric view of a first embodiment of a light guide plate.

FIG. 2 is a side view of the light guide plate of FIG. 1.

FIG. 3 is an enlarged view of a circled portion III of FIG. 2.

FIG. 4A shows light output from the light guide plate of FIG. 1.

FIG. 4B is a diagram of a light intensity distribution of the light of FIG. 4A.

FIG. 5 is a schematic, isometric view of a second embodiment of a backlight module.

FIG. 6 shows a side view of the backlight module of FIG. 5 in a state of use.

FIG. 7A shows a light output from the backlight module of FIG. 5.

FIG. 7B is a diagram of a light intensity distribution of the light of FIG. 7A.

### DETAILED DESCRIPTION

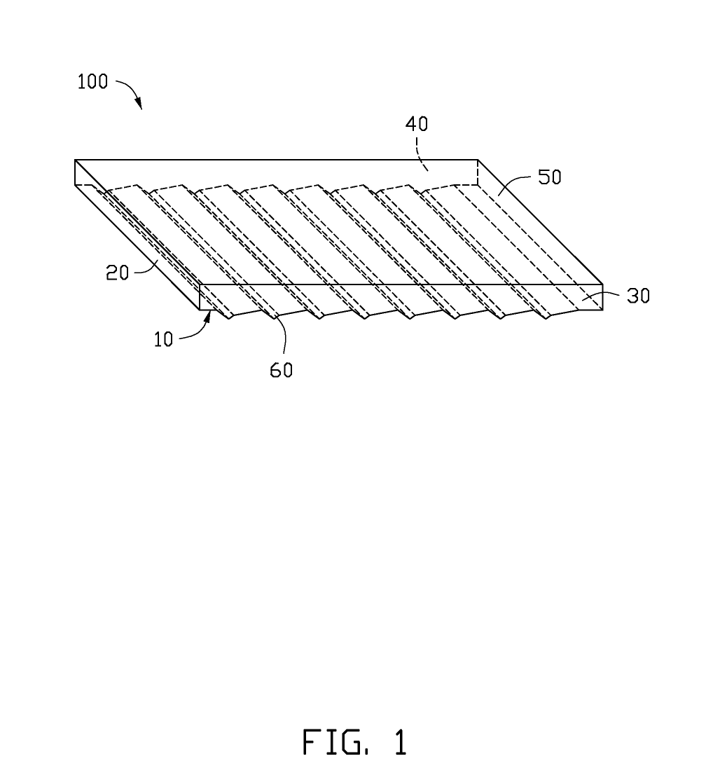

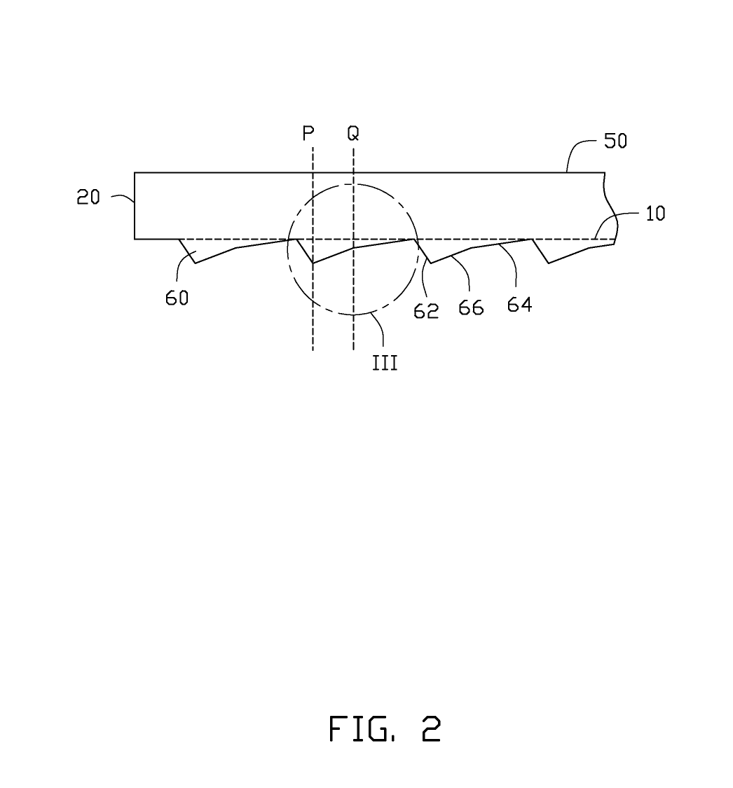

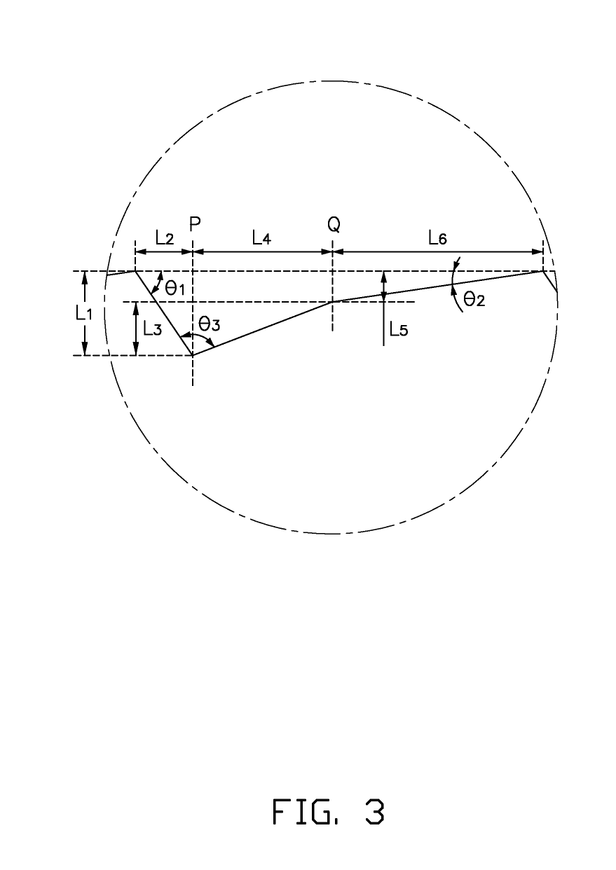

FIGS. 1 through 3 show a first embodiment of a light guide plate 100. The light guide plate 100 is substantially rectangular and includes a bottom surface 10, a light incident surface 20, a first side surface 30, a second side surface 40, and a light-emitting surface 50.

The bottom surface 10 is opposite and substantially parallel to the light-emitting surface 50. The first side surface 30 is opposite and substantially parallel to the second side surface 40. The light incident surface 20, the first side surface 30, and the second side surface 40 are connected substantially perpendicularly to the bottom surface 10 and the light-emitting surface 50. The light incident surface 20 is connected substantially perpendicularly to the first and second side surfaces 30, 40.

A plurality of ribs 60 protrude from the bottom surface 10 away from the light-emitting surface 50. Each rib 60 is a prism. In the illustrated embodiment, each rib 60 extends substantially parallelly from the first side surface 30 to the second side surface 40. Each rib 60 includes a first surface 62, a second surface 64, and a third surface 66. The first surface 62 is connected to the bottom surface 10. An included angle θ1 is defined between the first surface 62 and the bottom surface 10. The second surface 64 is connected to the bottom surface 10. An included angle θ2 is defined between the second surface 64 and the bottom surface 10. The third surface 66 is connected to the first and second surfaces 62, 64. An included angle θ3 is defined between the first and third surfaces 62, 66. The second surface 64 of each rib 60, with the exception of the rib 60 farthest from the light incident surface 20, is connected to a first surface 62 of an adjacent rib 60.

In this embodiment, the first and second. included angles θ1, θ2 are acute angles, the first included angle θ1 is bigger than the second included angle θ2, and the third included angle θ3 is an obtuse angle. In detail, the first included angle θ1 is arctan(2/3), the second included, angle θ2 is arctan(13/555), and the third included angle θ3 is arctan(3/2)+arctan(300/17). A normal line P substantially perpendicular to the bottom surface 10 intersects a junction of the first and third surfaces 62, 66, A normal line Q substantially perpendicular to the bottom surface 10 intersects a first junction of the second and third surfaces 64, 66. A length of an orthographic projection L1 of the first surface 62 on the normal line P is about 3 micrometers (μm), a length of an orthographic projection L2 of the first surface 62 on the bottom surface 10 is about 4.5 μm, a length of an orthographic projection L3 of the third surface 66 on the normal line P is about 1.7 μm, a length of an orthographic projection L4 of the third surface 66 on the bottom surface 10 is about 30 μm, a length of an orthographic projection L5 of the second surface 64 on the normal line Q is about 1.3 μm, and a length of an orthographic projection L6 of the second surface 64 on the bottom surface 10 is about 55.5 μm.

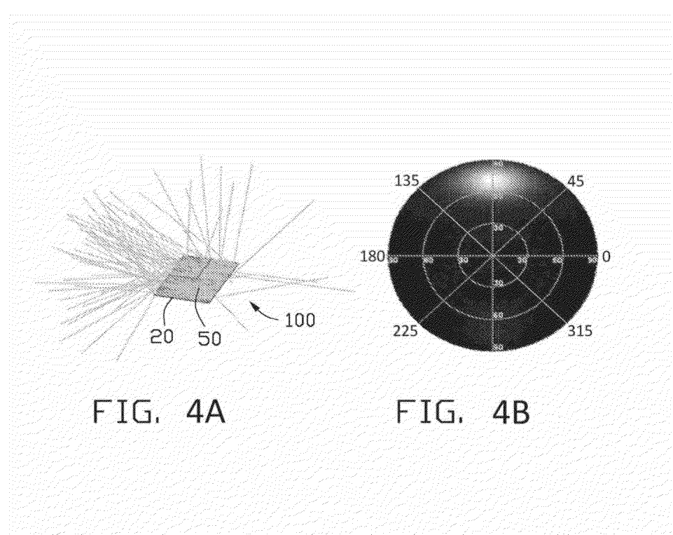

FIG. 4A shows light emitted from the light-emitting surface 50 of the light guide plate 100. FIG. 4B shows a light intensity distribution of the light emitted from the light-emitting surface 50. FIG. 4B shows that most of the light is emitted toward one side of the light guide plate 100 at about 12.2° relative to the light-emitting surface 50.

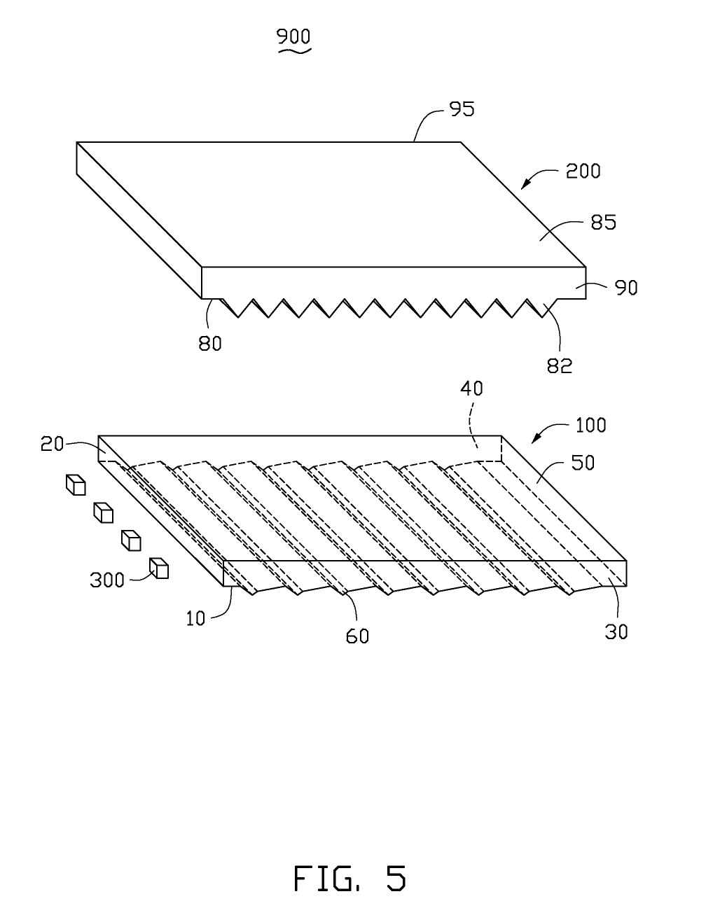

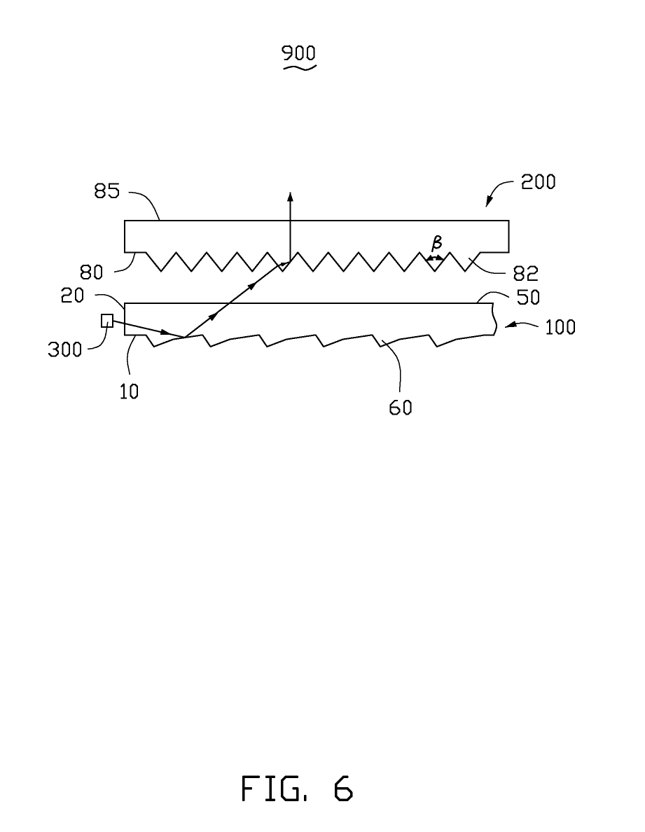

FIGS. 5 and 6 show a second embodiment of a backlight module 900. The backlight module 900 includes the light guide plate 100, a prism sheet 200, and four light sources 300.

In one embodiment, the prism sheet 200 is located above the light-emitting surface 50. The prism sheet 200 is substantially rectangular and includes a lower surface 80, an upper surface 85, a third side surface 90, and a fourth side surface 95. The lower surface 80 is opposite and substantially parallel to the upper surface 85. The third side surface 90 is opposite and substantially parallel to the fourth side surface 95. The third and fourth side surfaces 90, 95 are connected to the upper surface 85 and the lower surface 80. The third side surface 90 is adjacent to the first side surface 30, and the fourth side surface 95 is adjacent to the second side surface 40. A plurality of prisms 82 protrude from the lower surface 80. The prisms 82 extend from the third side surface 90 to the fourth side surface 95. The prisms 82 are substantially parallel to each other and to the ribs 60. The lower surface 80 and the prisms 82 face the light-emitting surface 50. In one embodiment, the prisms 82 are isosceles triangular prisms, and each prism 82 has a top angle β, which is about 70°.

The four light sources 300 face the light incident surface 20. Light emitted from the light sources 300 first enters the light guide plate 100 from the light incident surface 20. The light is then reflected by the ribs 60 and emitted from the light-emitting surface 50. The light emitted from the light-emitting surface 50 enters the prism sheet 200 from the lower surface 80 through the prisms 82. The prisms 82 reflect the light emitted from the light-emitting surface 50, and the light is emitted from the upper surface 85.

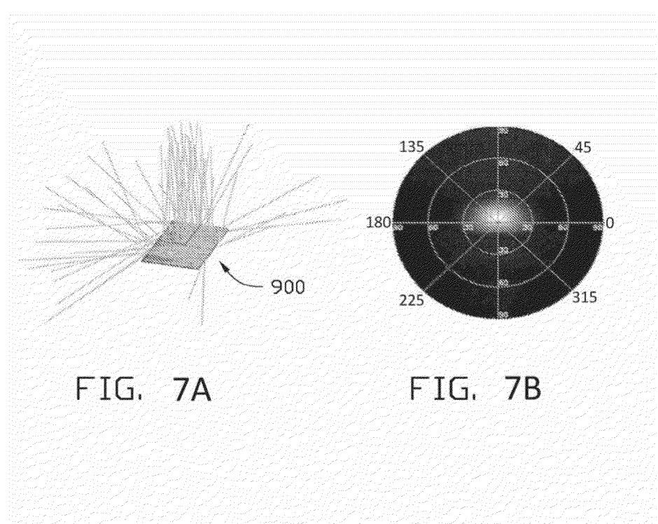

FIG. 7A shows light emitted from the upper surface 85 of the prism sheet 200. FIG. 7B shows a light intensity distribution of the light emitted from the upper surface 85. FIG. 7B shows that most of the light is emitted substantially perpendicularly from the upper surface 85.

The ribs 60 of the light guide plate 100 reflect light at an angle relative to the light-emitting surface 50, and the prism sheet 200 changes a direction of the light to emit the light substantially perpendicularly to the upper surface of the backlight module 900. Thus, a brightness of the backlight module 900 is enhanced, so the backlight module 900 does not require a brightness-enhancing film. Thus, a size of the backlight module 900 is reduced.

It will be understood that the above particular embodiments are shown and described by way of illustration only. The principles and the features of the present disclosure may be employed in various and numerous embodiments thereof without departing from the scope of the disclosure. The above-described embodiments illustrate the scope of the disclosure but do not restrict the scope of the disclosure.

What is claimed is:

1. A light guide plate comprising:
a bottom surface;
a light-emitting surface opposite to the bottom surface;
a light incident surface, a first side surface, and a second side surface connecting the bottom surface to the light-emitting surface respectively; and
a plurality of ribs protruding from the bottom surface away from the light-emitting surface, the ribs being prisms, extending from the first side surface to the second side surface, and being parallel to each other, each rib comprising a first surface, a second surface and a third surface, the first surface and the second surface respectively extending from the bottom surface, the second surface being away from the light incident surface relative to the first surface, a first included angle between the first surface and the bottom surface being an acute angle, the third surface connecting the first surface to the second surface.

2. The light guide plate of claim 1, wherein a second included angle between the second surface and the bottom surface is an acute angle and is smaller than the first included angle, and a third included angle between the third surface and the first surface is an obtuse angle.

3. The light guide plate of claim 2, wherein the first included angle is arctan(2/3), the second included angle is arctan(13/555), and the third included angle is arctan(3/2)+arctan(300/17).

4. The light guide plate of claim 3, wherein the a length of an orthographic projection of the first surface on the bottom surface is about 4.5 micrometers, a length of an orthographic projection of the second surface on the bottom surface is about 55.5 micrometers, and a length of an orthographic projection of the third surface on the bottom surface is about 30 micrometers.

5. A backlight module comprising:
a light guide plate comprising:
a bottom surface;
a light-emitting surface opposite to the bottom surface;
a light incident surface, a first side surface, and a second side surface connecting the bottom surface to the light-emitting surface respectively; and
a plurality of ribs protruding from the bottom surface away from the light-emitting surface, the ribs being prisms, extending from the first side surface to the second side surface, and being parallel to each other, each rib comprising a first surface, a second surface and a third surface, the first surface and the second surface respectively extending from the bottom surface, the second surface being away from the light incident surface relative to the first surface, a first included angle between the first surface and the bottom surface being an acute angle, the third surface connecting the first surface to the second surface;
at least one light source adjacent to the light incident surface; and
a prism sheet above the light-emitting surface.

6. The backlight module of claim 5, wherein a second included angle between the second surface and the bottom surface is an acute angle and is smaller than the first included angle, and a third included angle between the third surface and the first surface is an obtuse angle.

7. The backlight module of claim 6, wherein the first included angle is arctan(2/3), the second included angle is arctan(13/555), and the third included angle is arctan(3/2)+arctan(300/17).

8. The backlight module of claim 7, wherein the a length of an orthographic projection of the first surface on the bottom surface is about 4.5 micrometers, a length of an orthographic projection of the second surface on the bottom surface is about 55.5 micrometers, and a length of an orthographic projection of the third surface on the bottom surface is about 30 micrometers.

9. The backlight module of claim 5, wherein the prism sheet comprises an upper surface, a lower surface opposite to the upper surface, a third side surface, a fourth side surface opposite to the third side surface, and a plurality of second prisms protruding from the lower surface, the lower surface faces the light-emitting surface, the second prisms extend from the third side surface to the fourth side surface.

10. The backlight module of claim 9, wherein each second prism is an isosceles triangular prism and comprises a top angle facing the light-emitting surface, the top angle is 70°.
